(19) United States
(12) Patent Application Publication
(10) Pub. No.: US 2011/0274888 A1
(43) Pub. Date: Nov. 10, 2011

(54) Composite Material, Method for Producing a Composite Material and Adhesive or Binding Material

(76) Inventors: Xinhe Tang, Wien (AT); Helmut Hartl, Wien (AT)

(21) Appl. No.: 13/126,559

(22) PCT Filed: Oct. 20, 2009
(86) PCT No.: PCT/IB2009/007174

§ 371 Date: Aug. 1, 2011

(30) Foreign Application Priority Data
Oct. 29, 2008 (DE) 10 2008 053 736.5
Apr. 30, 2009 (DE) 10 2009 019 221.2
Jun. 22, 2009 (DE) 10 2009 030 118.6
Sep. 15, 2009 (DE) 10 2009 041 574.2

(51) Int. Cl. B32B 7/12; B32B 38/10; B32B 38/00; C23F 1/00; B32B 17/06; B32B 18/00; B32B 15/04; B32B 5/00; B32B 5/02; B32B 3/00; B32B 17/10; B32B 15/092; B32B 7/02; B32B 5/16; C08L 63/00; C08K 7/06; C09K 5/00; B32B 37/12; B82Y 30/00

(52) U.S. Cl. 428/189; 156/327; 156/330; 156/153; 156/272.8; 156/272.2; 216/35; 428/426; 428/446; 428/457; 428/336; 428/332; 428/612; 428/415; 428/416; 428/215; 428/551; 428/428; 428/448; 523/468; 523/440; 523/445; 252/74; 977/762; 977/734

(57) ABSTRACT

The invention relates to a composite material made up of at least one ceramic layer or at least one ceramic substrate and at least one metallization formed by a metallic layer on a surface side of the at least one ceramic substrate.

### BACKGROUND OF THE INVENTION

The invention relates to a composite material made up of at least one ceramic layer in a ceramic substrate of at least one metallization formed by a metallic layer on a surface side of the at least one ceramic substrate. Also described is a method for manufacturing such a composite material.

The manufacture of composite materials, also as printed circuit boards in the form of metal-ceramic substrates based on DCB technology (also DCB substrates) is known in the art. In this process, the metallization required for the manufacture of strip conductors, connections, etc. is applied on a ceramic, for example, on an aluminum-oxide ceramic, using DCB (direct copper bonding) technology, the metallization being formed by metal or copper foils or metal or copper sheets, comprising on the top side a layer or coating (melt layer) from a chemical bond with the metal and a reactive gas, preferably oxygen.

In this method, which is described for example in U.S. Pat. No. 3,744,120 and in DE-PS 23 19 854, this layer or coating (hot-melt layer) forms a eutectic with a melting temperature below the melting temperature of the metal (e.g. copper), so that the layers can be bonded to each other by placing the foil on the ceramic and heating all layers, namely by melting the metal or copper essentially only in the area of the hot-melt layer or oxide layer.

This DCB method then comprises for example the following steps:
Oxidation of a copper foil so as to produce an even copper oxide layer;
placing the copper foil on the ceramic layer;
heating the composite to a process temperature between approx. 1025 and 1083° C., e.g. to approx. 1071° C.;
cooling to room temperature.

Also known is the so-called active soldering method (DE 22 13 115; EP-A-153 618) for bonding metal layers or metal foils forming metallizations, in particular, copper layers or copper foils, with the respective ceramic material. In this process, which is used especially for manufacturing a metal-ceramic substrate, a bond is produced at a temperature of ca. 800-1000° C. between a metal foil, for example copper foil, and a ceramic substrate, for example aluminum-nitride ceramic, using a hard solder, which in addition to a main component such as copper, silver and/or gold also contains an active metal. This active metal, which is at least one element of the group Hf, Ti, Zr, Nb, Ce, creates a bond between the solder and the ceramic through a chemical reaction, while the bond between the solder and the metal is a metallic hard solder bond.

It is an object of the present invention to provide a composite material that can be manufactured in simple and economical manner, namely while maintaining optimum thermal properties.

Nanofiber material according to the present invention refers generally to nanofibers and/or nanotubes, and especially to carbon nanofibers and/or nanotubes.

Suitable nanofibers are, for example, nanofibers with the designation ENF-100-HT, HTP-150E-LHT, HTP-110FF-LHT and HTP-110E-HHT are offered by Electrovac AG, A-3400 Klosterneuburg, Austria.

Other nanofibers which can be used in the invention, also available from Electrovac AG, A-3400 Klosterneuburg, Austria, are listed in Table 1 below.

TABLE 1

| | | N2 | | | | | | |
|---|---|---|---|---|---|---|---|---|
| | | specific | | | Thermal | Electrical | Metal | |
| | Nanofiber | surface | Diameter | Length | conductivity | resistance | content | Density |
| Nanofiber | type: | [m2/g] | [nm] | [μm] | [W/mK] | [Ohm/cm] | [wt. %] | [g/cm3] |
| HTF150FF | AGF | 10-20 | 100-200 | >10 | >600 | <10⁻³ | <0.5 | 1.95 |
| HTF150FF | PSF | 20-30 | 100-200 | >10 | >600 | <10⁻³ | <0.5 | 1.95 |
| HTF150FF | LHT | 15-20 | 100-200 | >10 | >600 | <10⁻³ | <0.5 | >1.95 |
| HTF150FF | HHT | 15-25 | 100-200 | >10 | >600 | <10⁻³ | <0.01 | >1.95 |
| HTF110FF | AGF | 53 | 70-150 | >10 | >600 | <10⁻³ | <0.5 | 1.95 |
| HTF110FF | PSF | 50-60 | 70-150 | >10 | >600 | <10⁻³ | <0.5 | 1.95 |
| HTF110FF | LHT | 43 | 70-150 | >10 | >600 | <10⁻³ | <0.5 | >1.95 |
| HTF110FF | HHT | 41 | 70-150 | >10 | >600 | <10⁻³ | <0.01 | >1.95 |
| ENF100AA | HTE | 80-100 | 80-150 | >10 | >600 | <10⁻³ | <0.5 | 1.98 |
| ENF100AA | GFE | >50 | 80-150 | >10 | >600 | <10⁻³ | <0.01 | 2.17 |

Nanofiber type:
AGF as grown
PSF pyrolytic stripped carbon nanofiber
LHT heated at ~1,000° C.
HHT heated at ~3,000° C.
HTE heated at ~1,000° C. with EVAC
GFE heated or graphitized at ~3,000° C. with EVAC

Accordingly the following values apply:

| Nanofiber type | heated at |
|---|---|
| HTF 150 FF-LHT | ca. 1000° C. |
| HTF 150 FF-HHT | ca. 3000° C. |
| HTF 110 FF-LHT | ca. 1000° C. |
| HTF 110 FF-HHT | ca. 3000° C. |
| ENF 100 AA- HTE | ca. 1000° C. |
| ENF 100 AA - GFE | ca. 3000° C. - graphitized |
| ENF 100 HT | ca. 1000° C. |

The nanofibers or nanotubes for the most part, i.e. the majority, have a length between 1 and 100μ, a thickness between approximately 1 nm and 300 nm, for example, between approximately 1 nm and 100 nm or between approximately 50 nm and 150 nm or between approximately 1 nm and 100 nm, for example between approximately 3 nm and 75 nm.

### SUMMARY OF THE INVENTION

The composite material according to the invention is a multi-layer material, and preferably a multi-layer material or substrate that is suitable for electric circuits, modules, etc. made up of at least one plate-shaped carrier substrate having on at least one surface side of an electrically insulating material, preferably ceramic and/or glass substrate and at least one metallization formed by a metal plate or foil, the metallization is bonded with the substrate by means of an adhesive or bond layer.

In general, the metallization is made of copper, aluminum and/or of another metal or of a metal alloy and/or a metal composite and/or multi-layer material, e.g. of copper or aluminum alloy and/or of a copper/aluminum composite material and/or of an alloy such as those normally used for the manufacture of metal resistors.

The advantage of the composite material according to the invention is that it can be manufactured easily and economically. A further advantage consists in the fact that in particular the thickness of the metallizations can be selected as needed within a large range, for example in the range between approximately 0.01 mm and 4 mm. Further, the layer formed by the adhesive or bonding agent compensates different temperature expansion coefficients of the materials of the metallization and of the ceramic substrate. A compensating effect for the thermal expansion of the metallization can be achieved in the case of corresponding orientation of at least one part of the nanofiber material in the bond layer parallel or approximately parallel to the bonded surfaces.

The composition and/or layer thickness of the at least one adhesive or bond layer between at least one metallization and the carrier substrate, e.g. ceramic substrate, is chosen so that the thermal resistance of this adhesive or bond layer in an axis direction perpendicular to the surface sides of the metallization and/or of the carrier substrate is equal to or smaller than the thermal resistance of the carrier substance in this axis direction. For this purpose the content of nanofiber material is selected to be high and is, for example, 5 to 30 percent by weight relative to the total mass of the adhesive or bond layer. Further, the thickness of said adhesive or bond layer is chosen so that the surface sides of the at least one metallization and of the carrier substrate bonded to each other by means of this layer is not more than 50 μm, preferably approximately 5 μm to 25 μm from each other, i.e. the effective thickness of the bond layer is therefore no more than 50 μm, but preferably approximately 5 μm to 25 μm. This small clearance or this small effective thickness of the adhesive or bond layer is possible by use of the nanofiber material consisting of the very thin nanofibers and/or nanotubes, the length of at least the majority of these nanofibers or nanotubes being between 1 and 100 μm, for example primarily in the range of 10 μm.

Since nanofibers or nanotubes feature high thermal conductivity in the direction of their longitudinal extension, but the thermal conductivity radial to the longitudinal extension is limited and since the respective adhesive or bond surface should have only a small effective thickness for reduction of the thermal resistance, the surfaces bonded with each other by means of the adhesive or bond layer are provided with a surface roughness, namely the at least one metallization with a surface roughness between approximately 1 μm and 7 μm and the ceramic and/or glass substrate with a surface roughness between approximately 4 and 10 μm. The recesses formed by the surface roughness therefore create a space in which the nanofiber material can spread out or be oriented with its longitudinal extension perpendicular or at least oblique to the surface sides bonded with each other by means of the adhesive or bond layer, so that by means of the nanomaterial the desired thermal conductivity for the adhesive or bond layer is achieved.

A plastic is used as the matrix material for the respective adhesive or bond layer, the plastic, in combination with the nanofiber material, ensures a sufficiently high bond strength between at least one metallization and the adjoining carrier substrate, for example a bond strength on the order of at least 25 N/mm² (surface of the bonded metallization). The matrix material is chosen so that the hardened or cured adhesive or bond layer has a sufficiently high temperature resistance, so that the metal-ceramic substrate can be used as a base or printed circuit board or as a metal-ceramic substrate for electrical circuits or modules, the electrical and electronic components of which are mounted at least in industrial production exclusively using lead-free electronic solders, namely at soldering temperatures between approximately 265 and 345° C. A suitable material for the matrix material is therefore an epoxy resin or a plastic with an epoxy base, for example.

The manufacture of structured metallizations for forming strip conductors and/or contact surfaces and/or mounting surfaces, etc. can be achieved in different ways, in that after bonding of the respective metallization, i.e. after hardening of the adhesive or bond layer bonding the metallization with an adjoining layer, e.g. with the adjoining carrier substrate or with the adjoining ceramic substrate using a conventional technique, is structured using a masking and etching technique and afterwards the residual adhesive and bonding material remaining between the metal areas (strip conductors, contact surfaces, mounting surfaces, etc.) produced with the structuring is removed, e.g. mechanically or by machining, by means of sandblasting, laser treatment, etc.

To avoid this reworking, it is possible to apply the adhesive or bond material in structured form onto the surface provided with the structured metallization, namely in the form of structured areas which correspond with respect to their shape and position to the structured areas of the metallization. The metallization to be structured is then bonded by means of the structured areas of the adhesive or bond material. After hardening or curing of the adhesive or bond material, the metallization is structured using a suitable technique, by masking and etching, so that a structured, bonded metallization is produced, namely without any residue of adhesive and bond material between the metal areas of the metallization. Generally, the adhesive and bond material is applied by means of masks and/or screens and/or by spraying and/or by rolling and/or by spin-coating.

It is further possible to manufacture the layout of the structured metallization, i.e. the metal elements or pads forming the metal areas of the structured metallization by stamping from a suitable flat metal material, e.g. from a metal foil and then, using the adhesive or bond material, bonding to a surface area provided with the structured metallization, and this surface area then is either provided on its entire surface with a layer of the adhesive or bond material and after bonding, i.e. after hardening or curing, this material is removed from between the metal areas of the structured metallization using suitable means, or the adhesive and bond material is applied in structured form to the surface area to be provided with the structured metallization, i.e. it is applied only where it is needed for bonding a metal area of the structured metallization. It is further possible to apply the adhesive or bond material only to the metal elements or pads forming the structured metallization.

It is possible to design the composite material according to the invention as a multiple substrate, in the form of at least two single substrates bonded to each other by means of at least one adhesive or bond layer, of which (single substrates) then at least one likewise is designed as a bond material or metal-ceramic and/or glass composite material or substrate.

The use of the nanofiber material in the adhesive or bond layer 5 or in the adhesive or bond material not only improves the thermal conductivity of the adhesive or bond layer; but use of the nanofiber material also reduces the thermal expansion coefficient and the elastic properties of the adhesive and bond layer wherein a very rigid bond is produced between the respective metallization 3 or 4 and the carrier substrate 2. This makes it possible, through corresponding choice of the material for the carrier substrate 2, to adapt the composite material 1 as a whole with respect to its thermal expansion coefficient to that of semiconductor material and therefore to reduce temperature-related mechanical tensions between semiconductor elements or semiconductor chips mounted on the composite material or on a printed circuit board made of this composite material and to prevent defects in the respective electronic circuit or module which are caused by temperature-related mechanical tensions.

Preferably, the content of nanofiber material in the adhesive or bond material is chosen so that sufficiently thin processing of this material is possible, namely for forming an adhesive or bond layer with a thickness of less than 25 μm, preferably between 4 and 25 μm, namely for achieving the lowest possible thermal resistance for the adhesive or bond layer, e.g. in a substrate used as a printed circuit board and therefore for achieving the lowest possible thermal resistance for the composite material or the substrate as a whole.

Due to the nanofiber material and due to the low thickness, the very thin adhesive and bond layer in the manner described above exhibits no or only very little elasticity, thus improving the resistance to changes in temperature and the life of semiconductor circuits and modules. Further, due to the low thickness, such surfaces or volumes of the adhesive or bond layer which (surfaces or volumes) can be affected by external media, such as water or humidity, are reduced enormously, which also contributes significantly to the long life of the composite material and of an electrical circuit or module manufactured using this composite material.

The nanofiber material is purified prior to being mixed into the plastic matrix, for example heated, namely with the goal of removing impurities, especially metallic impurities and/or catalysts, in particular ones which can affect the plastic material used for the matrix and/or its properties.

In addition to the nanofiber material, the adhesive or bond material contains other additives or fillers, in particular chemical or neutral additives or fillers, for example carbon or graphite, ceramic, etc.

In a further embodiment of the invention, the composite material is designed so that the carrier substrate is plate-shaped or essentially plate-shaped and/or that the carrier substrate is a ceramic and/or glass layer or a ceramic and/or glass substrate, for example, an aluminum oxide and/or aluminum nitride and/or silicone nitride,

and/or

at least one metallization, in the area of the adhesive or bond layer, exhibits a distance from the adjoining layer smaller than 50 μm, preferably a distance on the order of a maximum of 25 μm or between approximately 5 μm and 25 μm.

and/or

that one first metallization is provided on the top side of the carrier substrate and one second metallization is provided on the bottom side of the carrier substrate and that at least one of these metallizations is structured,

and/or

the adhesive or bond layer bonding the at least one metallization to the carrier substrate is chosen with respect to its layer thickness and/or composition so that the thermal resistance exhibited by the adhesive or bond layer in one axial direction perpendicular to the mutually adjoining surface sides of the metallization and of the carrier substrate is small or, at the maximum, equal to the thermal resistance of the carrier substrate in this axial direction,

and/or

the nanofiber material is a carbon nanofiber material and/or the content of the nanofiber material in the adhesive or bond material is between 5 and 30 percent by weight, namely relative to the total weight of this material,

and/or

the nanofiber material is made of nanofibers and/or nanotubes, preferably at least the majority of these nanofibers or nanotubes having a length between 1 μm and 100 μm and a thickness between approximately 1 nm and 300 nm or between approximately 50 nm and 150 nm or between approximately 1 nm and 100 nm, for example between approximately 3 nm and 75 nm,

and/or

the at least one metallization and/or the at least one carrier substrate in the area of the adhesive or bond layer are provided with a surface roughness, namely the metallization for example with a surface roughness between approximately 1 μm and 7 μm and/or the carrier substrate for example with a surface roughness between 4 μm and 10 μm,

and/or

the surface roughness is produced mechanically and/or physically and/or chemically, e.g. by sandblasting and/or by intergranular etching and/or by plasma treatment and/or by deposition of a layer comprising copper and one further metal and by subsequent etching of the further metal,

and/or

the bond layer consists of a matrix with an epoxy base or an epoxy-resin base,

and/or

the adhesive or bond layer or the adhesive or bond material forming said layer contains further additives, for example flame-retarding additives, e.g. halides or boron compounds,

and/or

the plastic material forming the matrix of the adhesive or bond material is chosen so that the adhesive or bond layer in hardened and/or cured condition has a temperature resistance of at least 220° C.,

and/or

the at least one metallization at least in partial areas consists of a metal alloy and/or of a metal composite and/or multi-layer material, e.g. of an aluminum/copper multi-layer material,

and/or

the at least one metallization consists at least partially of copper, of a copper alloy, of aluminum, of an aluminum alloy and/or of a highly resistive metal material and/or of at least one metal foil, for example of copper, of a copper alloy, of aluminum, of an aluminum alloy and/or of the highly resistive metal material,

and/or

the at least one metallization has a thickness between approximately 0.01 mm and 4 mm, for example between approximately 0.03 mm and 0.8 mm and/or the at least one carrier substrate has a thickness between approximately 0.1 mm and 1.2 mm, for example between approximately 0.25 mm and 1.2 mm.

and/or

the at least one metallization is bonded by means of the adhesive or bond layer with a bonding strength (peel-off strength) of at least 1 N/mm, preferably with a bond strength of at least 2.5 N/mm to the adjoining layer, for example to the adjoining carrier substrate,

and/or

the at least one metallization is structured for forming structured metal areas, for example in the form of strip conductors, contact and/or mounting surfaces, and that the adhesive and bond layer is not provided or is removed between adjoining structured metal areas,

and/or

the metallization at least on one surface side of the at least one carrier substrate forms an electrical connection protruding over an edge area of the composite material or of the carrier substrate, for example a connection produced from a leadframe,

and/or

the at least one carrier substrate and/or the at least one metallization is bonded by means of the adhesive or bond layer made of the adhesive or bond material to a leadframe or to bridge sections of said leadframe,

and/or

it is designed as a multi-layer substrate made of at least two single substrates and the single substrates are bonded to each other by means of at least one adhesive or bond layer formed from the adhesive or bond material,

and/or

the at least one adhesive or bond layer is free of gas and/or vapor bubbles, in particular air bubbles or the content by volume of such bubbles relative to the total volume of the at least one adhesive or bond layer is no more than 0.1 percent by volume,

and/or

the adhesive or bond layer also contains pulverized additives, such as carbon, graphite, ceramic and/or metal additives,

and/or

the nanofiber material is a metal-free or essentially metal-free nanofiber material, in particular a nanofiber material without Ni, Fe and/or Co and/or a chemically and/or is a thermally pre-treated nanofiber material,

and/or

the total content of the nanofiber material and any additional constituents in the plastic matrix of the adhesive or bond layer is chosen so that the glass transition temperature of the adhesive or bond material or of the plastic matrix is at least 150° C. and/or is higher by at least 25% compared with the glass transition temperature of the plastic forming the plastic matrix, for example epoxy,

and/or

the total content of nanofiber material and of any additional additives is approximately 25% by weight relative to the total mass of the adhesive or bond layer,

and/or

the total content of nanofiber material and any further additives is chosen so that a thickness of less than 25 μm is possible for the at least one adhesive or bond layer,

and/or

the total content of nanofiber material and any further fillers is chosen so that the thermal conductivity of the adhesive or bond layer is greater by at least the factor of five compared with the thermal conductivity exhibited by the plastic forming the plastic matrix, for example greater than 1 W/mK,

and that the above characteristics can be provided individually or in any combination.

In further embodiments of the invention, the method for manufacturing a composite material is designed so that

the metal layer or metal foil and/or the carrier substrate prior to bonding are roughened on their surface sides to be bonded to each other, namely preferably for achieving a roughness of approximately 1 μm to 5 μm for the metal layer or foil and/or for achieving a roughness of approximately 4 μm to 10 μm for the carrier substrate,

and/or

the surface roughness is produced mechanically and/or physically and/or chemically, for example by sandblasting and/or by pumicing and/or by intergranular etching and/or by plasma treatment and/or by deposition of a metal layer consisting of the metal of the metallization and a further metal and by subsequent removal of the further metal by etching,

and/or

an adhesive or bond material, which in addition to the nanofiber material contains further additives, for example flame retardant additives, e.g. halides and/or nitride compounds, etc.,

and/or

the metallization bonded by means of the adhesive or bond layer to an adjoining layer, for example to the carrier substrate, is structured,

and/or

the adhesive or bond material is applied full-surface to the area to be provided with the metallization of the adjoining layer, e.g. of the carrier substrate, and after structuring of the metallization the adhesive or bond layer between the metal areas of the structured metallization is removed, e.g. mechanically, e.g. by sandblasting, by laser treatment or plasma treatment,

and/or

the adhesive or bond material, prior to application of the at least one metallization to be structured is applied in a form and position corresponding to the form and position of the metal areas of the structure metallization to the metallization to be bonded or to the metal layer forming said metallization and/or to the surface area of the adjoining layer to be provided with the metallization, for example of the carrier substrate,

and/or

for producing at least one structured metallization on one surface side of an adjoining layer, for example on a surface side of the carrier substrate, the layout or the metal areas of the metal elements or pads forming the structured metallization, for example by stamping, are provided in a position corresponding to the structured metallization and bonded to the adjoining layer using the adhesive and bond material,

and/or

the provision of the metal elements or pads takes place by arranging these elements in a mask or form and/or by positionally exact application of these elements on an auxiliary carrier or a carrier material,

and/or

the adhesive or bond material is applied full-surface to the surface to be provided with the structured metallization of the adjoining area and after bonding, i.e. after curing and/or hardening of the adhesive or bond material the latter is removed between the metal areas of the structured metallization, for example mechanically, e.g. by sandblasting and/or by laser or plasma treatment.

and/or

the adhesive or bond material is applied in structured form onto the surface side of the adjoining layer to be provided with the structured metallization in a form and position corresponding to the metal areas or pads of the structured metallization and/or is applied to the surface side of the provided metal elements to be bonded to the adjoining layer,

and/or

the at least one metallization at least in partial areas consists of a layer or foil made of copper or aluminum or of a highly resistive metal material,

and/or

the at least one metallization at least in partial areas consists of copper and/or aluminum and/or a metal alloy, e.g. of a copper alloy or aluminum alloy and/or of a metal composite and/or multi-layer material, e.g. of an aluminum/copper multi-layer material, for example in the form of a metal foil,

and/or

the composite material, after application of the at least one metallization, in particular also for improving the thermal conductivity is post-treated by tempering, namely for example at a temperature equal to or higher than the bonding temperature used to cure the adhesive and bond material,

and/or

the adhesive and bond material is applied to the carrier substrate using masks, in particular hole masks, templates, screens, by spraying, rolling and/or spin-coating,

and/or

the full-surface and/or structured application of the adhesive or bond material takes place using at least one mask and/or template and/or using the screen resist method,

and/or

the bonding and/or post-treatment or the tempering take place under pressure,

and/or

the conditioning of the adhesive or bond material and/or the bonding takes place so that the adhesive or bond layer formed by the adhesive or bond material at least in the finished composite material is free of gas and/or vapor bubbles, in particular air bubbles, and the content by volume of such bubbles in the adhesive or bond layer relative to the total volume of this layer is no more than 0.1% by volume,

and/or

the adhesive or bond layer also contains pulverized additives, such as carbon, graphite, ceramic and/or metal additives,

and/or

the nanofiber material is a metal-free or essentially metal-free nanofiber material, in particular a nanofiber material without Ni, Fe and/or Co and/or a chemically and/or is a thermally pre-treated nanofiber material,

and/or

the total content of the nanofiber material and any additional constituents in the plastic matrix of the adhesive or bond layer is chosen so that the glass transition temperature of the adhesive or bond material or of the plastic matrix is at least 150° C. and/or is higher by at least 25% compared with the glass transition temperature of the plastic forming the plastic matrix, for example epoxy, and/or the total content of nanofiber material and any further additives is approximately 25% by volume relative to the total mass of the adhesive or bond layer,

and/or

the total content of nanofiber material and any further additives is chosen so that a thickness of less than 25 μm is possible for the at least one adhesive or bond layer,

and/or

the total content of nanofiber material and any further fillers is chosen so that the thermal conductivity of the adhesive or bond layer is greater by at least the factor of four, preferably by the factor of five compared with the thermal conductivity exhibited by the plastic forming the plastic matrix without nanofiber material and without any additional fillers, for example greater than 1 W/mK,

and that the above characteristics can be used individually or in any combination.

In a further embodiment of the invention, the bond material is designed for example so that the nanofiber material is a carbon nanofiber material and/or the content of the nanofiber material in the adhesive or bond material is between 5 and 30 percent by weight, namely relative to the total weight of this material,

and/or

the nanofiber material is made of nanofibers and/or nanotubes, preferably at least the majority of these nanofibers or nanotubes having a length between 1 μm and 100 μm and a thickness between approximately 1 nm and 300 nm or between approximately 50 nm and 150 nm or between approximately 1 nm and 100 nm, for example between approximately 3 nm and 75 nm,

and/or

the matrix is such a matrix with an epoxy base or an epoxy-resin base,

and/or

it contains further additives, for example flame-retardant additives, e.g. halides or boron compounds,

and/or

the plastic material forming the matrix is chosen so that in hardened and/or cured condition it has a temperature resistance of at least 220° C.,

and/or

it contains pulverized additives, such as carbon, graphite, ceramic and/or metal additives,

and/or

the nanofiber material is a metal-free or essentially metal-free nanofiber material, in particular a nanofiber material without Ni, Fe and/or Co and/or a chemically and/or is a thermally pre-treated nanofiber material,

and/or

the total content of the nanofiber material and any additional constituents is chosen so that the glass transition temperature of the bond material or adhesive or of the plastic matrix is at least 150° C. and/or is higher by at least 25% compared with the glass transition temperature of the plastic forming the plastic matrix, for example epoxy, and/or the total content of nanofiber material and any further additives is approximately 25% by volume relative to the total mass of the adhesive or bond layer,

and/or

the total content of nanofiber material and any further fillers is chosen so that the thermal conductivity of the bond material or adhesive is greater by at least the factor of five compared with the thermal conductivity exhibited by the plastic forming the plastic matrix, for example greater than 1 W/mK,

and that the above characteristics can be provided individually or in any combination.

Further embodiments, advantages and applications of the invention are also disclosed in the following description of exemplary embodiments and the drawings. All characteristics described and/or pictorially represented, alone or in any combination, are subject matter of the invention, regardless of their being summarized or referenced in the claims. The content of the claims is also an integral part of the description.

### BRIEF DESCRIPTION OF THE DRAWINGS

The invention is described in more detail below based on exemplary embodiments, in which:

FIG. 1 is a simplified representation in cross section of a metal-ceramic composite material in the form of a metal-ceramic substrate according to the invention;

FIG. 2 is an enlarged partial representation of the adhesive or bond layer between a metallization and a carrier substrate in the form of a ceramic substrate of the metal-ceramic substrate in FIG. 1;

FIG. 3 is a simplified representation in side view of a dome-shaped metal-ceramic substrate;

FIG. 4-8 respectively are simplified depictions of various process steps in the manufacture of a metal-ceramic substrate with structured metallizations of the substrate top side;

FIG. 9 is a simplified representation in top view of a partial length of a leadframe together with metal-ceramic substrates provided on the leadframe;

FIG. 10 is a simplified representation in cross section of one of the metal-ceramic substrates provided on the leadframe;

FIG. 11 is a simplified representation in side view of a multiple substrate consisting of two metal-ceramic substrates;

FIG. 12 is an enlarged cross section view of the ceramic substrate together with a structured metal area;

FIG. 13 is a simplified representation showing the form of a structured application of the adhesive or bond material for bonding a metallization, preferably a structured metallization;

FIG. 14 is a schematic partial representation in top view of a mask for dosed application of the adhesive or bond material forming the adhesive or bond layer; and

FIG. 15 is a schematic representation in side view showing a measuring arrangement for determining the bonding strength (peel-off strength) of the metallization applied to the carrier layer.

### DETAILED DESCRIPTION OF THE INVENTION

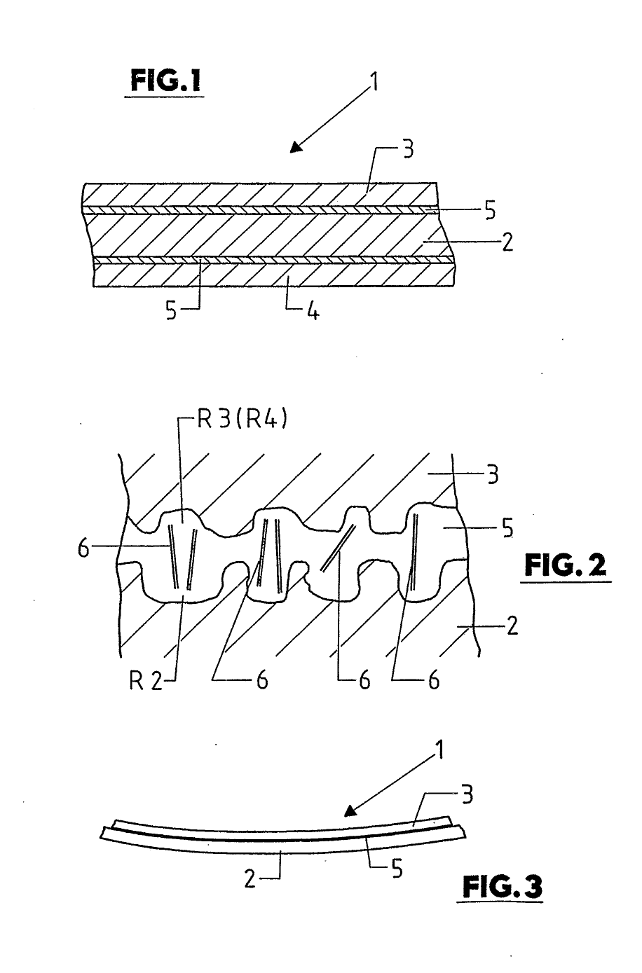

The metal-ceramic composite material or metal-ceramic substrate generally designated 1 in FIG. 1 and which is suitable as a printed circuit board for electrical circuits or modules, is made up of a plate-shaped carrier substrate 2 in the form of a ceramic substrate made of an aluminum oxide ceramic, aluminum nitride ceramic or silicone nitride ceramic.

On both surface sides of the substrate a metallization 3 and 4 formed by a metal foil, for example by a foil made of copper or a copper alloy, is provided respectively on both surface sides of the substrate, said metallization being bonded full-surface to the substrate 2 by means of an adhesive or bond layer 5 formed by an adhesive or bond material. In the case of the embodiment depicted in FIG. 1 the metal-ceramic substrate is symmetrical to an imaginary substrate middle plane, namely by the fact that both metallizations 3 and 4 and also the two adhesive and bond layers 5 respectively have the same thickness, the two metallizations 3 and 4 respectively are made of the same metal, namely copper, and also that the same adhesive or bond material is used for the adhesive and bond layers 5.

The adhesive or bond material for the adhesive or bond layers 5 is made up of a plastic matrix suitable as an adhesive, the matrix contains, among other things, carbon nanofiber material, for example relative to the total weight of the adhesive or bond material a content of approximately 5-30% by weight of nanofiber material, and possibly also further additives, for example in the form of thermally conductive materials, e.g. graphene and/or graphite and/or in the form of flame-retardant additives, such as halides or boron compounds, in which case, however the nanofiber material is already effectively flame-retardant so that a further flame-retardant additive is basically unnecessary.

In a preferred embodiment, the nanofiber material is made up of a carbon nanofiber commercially available as “Pyrograph III”. This material is heated at a temperature of 3000° C. before being mixed into the matrix, and before any pre-treatment, if applicable.

The material used for the matrix is chosen so that the respective adhesive or bond layer 5, hardens at room temperature or at a higher temperature, for example at a temperature between 120° C. and 180° C., exhibits sufficiently high thermal stability or a sufficiently high decomposition temperature so that the metal-ceramic substrate 1 in the case of use as a printed circuit board also is still stable at the high solder temperatures of approximately 265° C.-345° C. as required by the normal electronic solders used today, for example with a Sn/AG, Sn/Cu or Sn/Ag/Cu base. Therefore, it is expedient to use a plastic material for the matrix which is stable at least at 350° C. for 5 minutes. Since the respective solder temperature is applied only briefly during soldering, however, a temperature resistance of at least 220° C. for the adhesive or bond layer is sufficient.

Most suitable for use as the matrix material is a plastic with an epoxy or epoxy-resin base. To achieve optimum binding of the nanofiber material in the matrix material, a solvent is used. Especially suitable for this purpose is triethyleneglycol monobutylether.

The thickness of the substrate 2 is between 0.1 mm and 1.2 mm, for example between 0.38 mm and 1 mm. The thickness of the metallizations or of the metal or copper layers or foils forming these metallizations 3 and 4 can fundamentally be chosen as desired, between 0.01 mm and 4 mm.

The thickness of the respective adhesive or bond layer 5 is chosen so that the thermal resistance exhibited by the bond layer 5 in an axis direction perpendicular to the surface sides of the metal-ceramic substrate 1 is smaller or at the maximum equal to the thermal resistance exhibited by the substrate 2 in this axis direction. Even when taking into account the significantly reduced thermal resistance due to the high content of carbon nanofiber material, this results in a maximum layer thickness of 50 μm for the two adhesive or bond layers 5 and preferably a layer thickness of less than 25 μm, e.g. between 5 μm and 25 μm.

The desired reduction of the thermal resistance for the adhesive or bond layers 5 can be achieved, however, only if despite the greatly reduced thickness of the bond layers 5 or of the greatly reduced distance between the mutually facing surface sides of the substrate 2 and of the respective metallization 3 and 4, the single nanofibers or nanotubes of the carbon nanofiber material are oriented so that with their longitudinal extension they form a conductive bridge between the mutually facing surface sides of the substrate 2 and of the metallization 3 and 4, i.e. at least for the most part they are not oriented parallel or essentially parallel to these surface sides. To achieve this, despite the small distance between the substrate 2 and the respective metallization 3 and 4, the mutually facing surface sides are designed with a surface roughness corresponding to FIG. 2, namely the metallizations 3 and 4 or the copper foils forming these metallizations are provided with a surface roughness R3/4 of approximately 1 μm to 7 μm and the substrate 2 is provided with a surface roughness R2 between approximately 4 μm and 10 μm, so that also nanofibers or nanotubes with a greater length can orient in the optimal manner for optimal heat thermal transfer and therefore for reduction of the thermal resistance within the recesses produced by the roughness in the direction of the thickness of the respective adhesive or bond layer 5, as schematically indicated in FIG. 2 by the lines 6.

The surface roughness of the metallizations 3 and 4, can be produced in various ways, for example, by a mechanical and/or physical and/or chemical treatment, e.g. by sandblasting and/or pumicing, i.e. by treating the respective surface with pumice stone particles, and/or plasma treatment and/or by intergranular etching or also by deposition of a compound containing copper and at least one further metal on the surface side provided with the roughened surface and by subsequent removal of the further metal by etching.

The surface roughness of the substrate 2 and of the metallizations 3 also achieves improved wetting of these surfaces during application of the adhesive and bonding material as well as improved strength of the bond between the ceramic substrate and the respective metallization, for example a bond strength or peel-of strength of at least 1 N/mm, preferably of at least 2.5 N/mm. This high bond strength is likewise decidedly the result of the orientation of the nanofiber material crosswise to the adhesive or bond layer 5.

The thermal expansion coefficient of the metal-ceramic substrate 1 as compared with the thermal expansion coefficient of the metal material used for the metallizations 3 and 4, for example of the copper, is greatly reduced and corresponds approximately to the thermal expansion coefficient of semiconductor material. This is achieved by the fact that the adhesive and bond layers 5 are extremely stable due to the nanofiber material and that an extremely stable bond of the metallizations 3 and 4 to the substrate 2 also exists due to this nanofiber material, so that the thermal expansion coefficient of the metal of the metallizations 3 and 4 is greatly reduced both due to the nanofiber material and in particular also due to the ceramic material of the substrate 2.

It cannot be prevented that at least part of the nanofibers or nanotubes of the carbon nanofiber material outside of the recesses of the surface roughness between the mutually facing surface sides of the substrate 2 and of the metallizations 3 and 4 are oriented with the longitudinal extension parallel or essentially parallel to these surface sides. However, since the nanofibers or nanotubes have a very small diameter, even if by chance several nanofibers or nanotubes are located on top of each other, the extremely small distance between the mutually facing surface sides of the substrate 2 and the respective metallization 3 and 4 of only 50 μm or 5 μm to 25 μm can be maintained.

The hardening of the material forming the adhesive or bond layers 5 can take place at room temperature or at an increased temperature, at a temperature between room temperature and 120° C.-180° C., in a kiln (also a tunnel kiln), under pressure in a heated press, by induction, by heat radiation, etc. Afterwards, preferably post-treatment takes place by tempering at an increased tempering temperature over an extended time period, at a temperature at least higher than the maximum temperature which occurs during the later use of the substrate as a printed circuit board in a circuit or module. As a result of the post-treatment the thermal conductivity for example can be improved, i.e. increased, for example by approximately 50%.

Especially in the case of hardening of the adhesive or bond material at an increased temperature and in the case of application of only one metallization, for example only of the metallization 3 on the top side of the substrate 2 or in the case of use of metal or copper foils of different thicknesses for the metallization 3 and 4, a controlled curvature for the metal-ceramic substrate 1 can be achieved, as depicted schematically in FIG. 3. This curvature is due to the fact that the metal material or copper of the metallization 3 on the top side of the substrate 2 expands more strongly during heating than the ceramic material of the substrate 2 and after curing of the adhesive or bond layer 5 and the subsequent cooling, contracts more strongly than the substrate 2, resulting in a concave curvature of the metal-ceramic substrate 1 on the top side formed by the metallization 3. If no curvature is desired, this can be prevented by the afore-mentioned symmetrical design of the metal-ceramic substrate, but also in the case of a non-symmetrical design, by having the hardening of the adhesive or bond layers 5 take place at reduced temperature, for example at room temperature.

In order for the metal-ceramic substrate 1 to be suitable as a printed circuit board for electric circuits or modules, it is necessary to structure at least one of the two metallizations, for example the metallization 3 to form strip conductors, contact surfaces, mounting surfaces, etc.

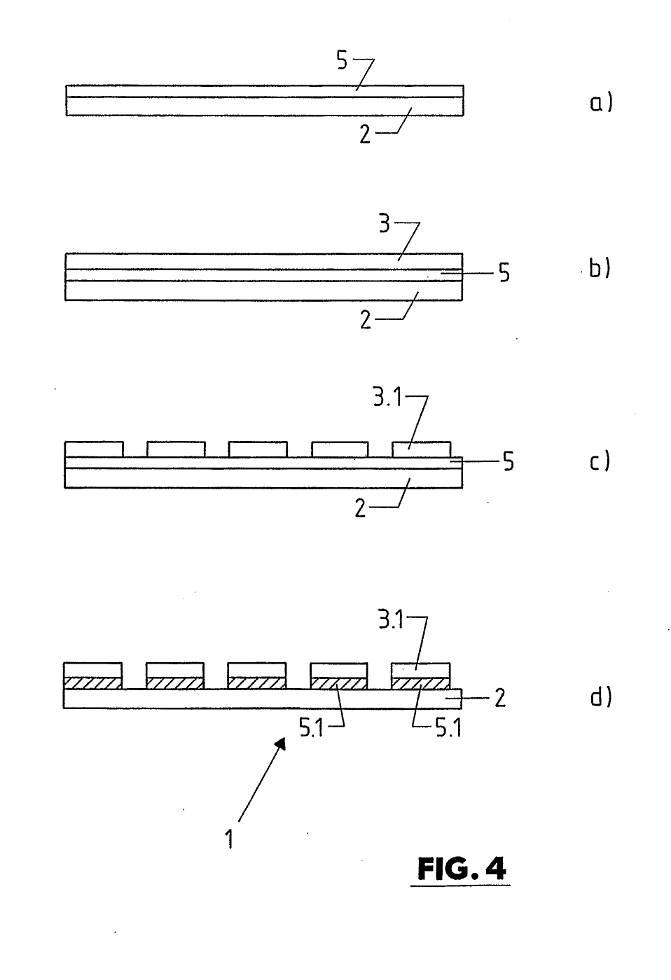

FIGS. 4-7 show various methods for manufacturing the metal-ceramic substrate 1 with the structured metallization 3, in which case to simplify the depiction in these figures the bonding of the metallization 4 is not depicted, which takes place simultaneously with the bonding of the metallization 3 and/or at another point in time of the process, e.g. not until after the complete manufacture of the structured metallization 3 with the metal areas 3.1 on the top side of the metal-ceramic substrate 1.

In the case of the process depicted in FIG. 4, the adhesive or bond layer 5 is first applied with the required thickness to the top side of the substrate 2 (Position a). Afterwards, the metallization 3 or the copper layer forming this metallization is applied in non-structured form (Position b). In a subsequent process step, after hardening of the adhesive or bond layer 5, the structuring of the metallization 3 for forming the structured metal surfaces or areas 3.1 or the strip conductors, contact surfaces, mounting surfaces, etc. takes place, namely for example using a known masking and etching technique (Position c). In a subsequent process step the unneeded residue of the adhesive or bond layer 5 between the single structured metal areas 3.1, i.e. where they are not covered by a structured metal area 3.1, is then removed, namely for example by sandblasting or by a plasma treatment, so that the adhesive or bond material is present only as structured adhesive or bond layer 5.1 under the metal areas 3.1.

In further process steps, a post-treatment, for example by tempering and/or by deburring and/or by application of a surface layer of nickel and/or gold to the top side of the structured metal areas 3.1 then takes place.

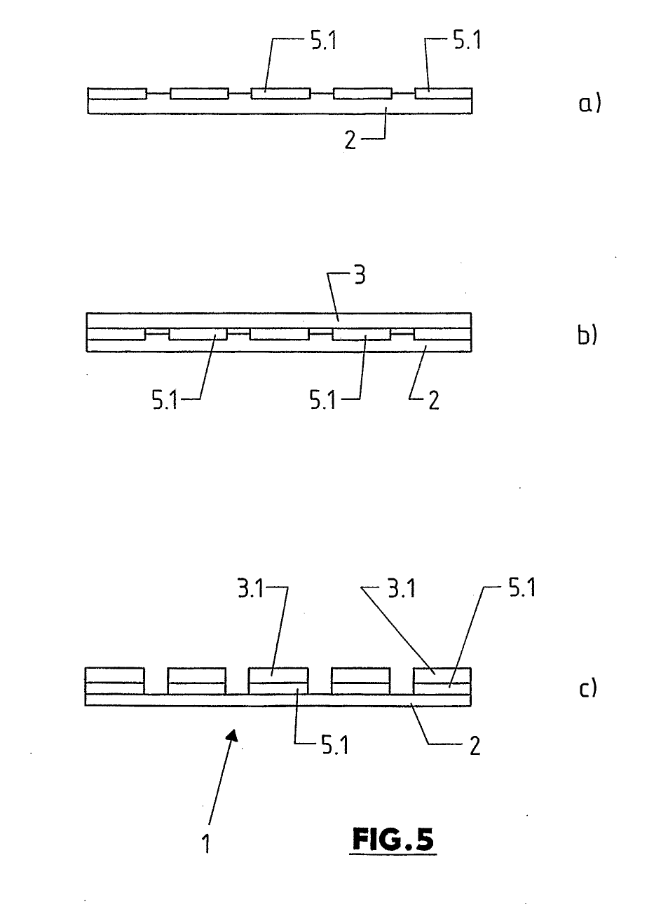

FIG. 5 shows a further possibility for manufacturing the metal-ceramic substrate with the structured metallization 3. In this process the adhesive or bond layer 5 is applied to the substrate 2 in structured form, namely so that the adhesive and bond layer 5 or its structured areas 5.1 exist only where later a structured metal area 3.1 is to be provided (Position a). Afterwards, the metal foil forming the metallization 3 is applied in non-structured form and is bonded to the substrate 2 by hardening of the structured areas 5.1 (Position b). In a further process step using for example a masking and etching technique, the structuring of the metallization 3 takes place, i.e. the formation of the structured metal areas 3.1 in the form that the structured metal areas 3.1 are bonded to the substrate 2 by means of the hardened structured adhesive and bond material 5.1.

The structured application of the adhesive or bond material takes place for example using at least one mask, by screen printing or another suitable method. After structuring of the metallization 3, further post-treatment process steps can follow, such as was described above in connection with FIG. 4.

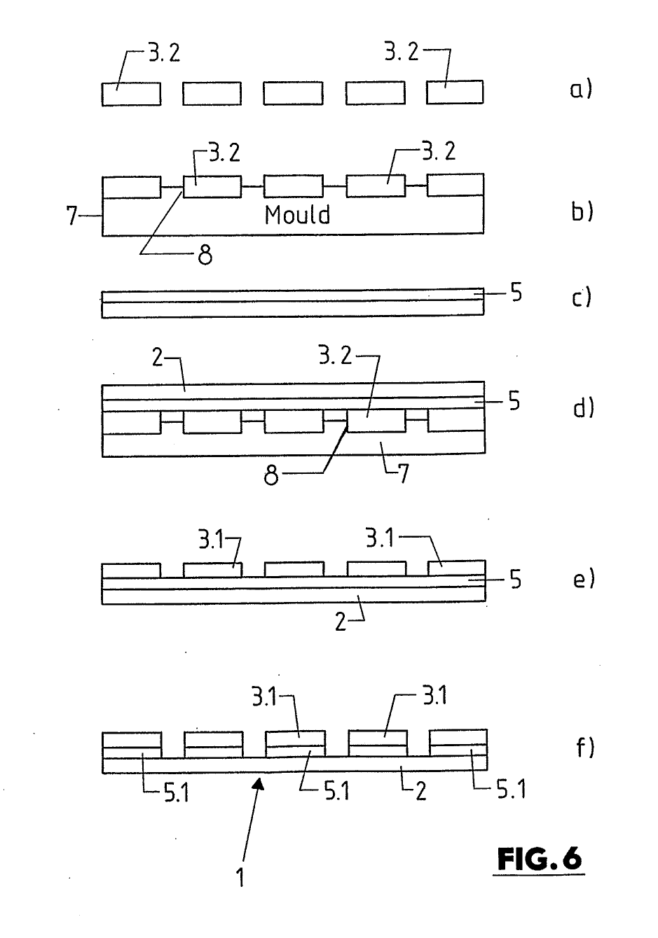

FIG. 6 depicts the essential process steps of an especially ecological and efficient process. In this process, metal elements or pads 3.2 are first produced for example by stamping the form of which corresponds to the layout of the structured metallization 3 or the structured metal areas 3.1 (Position a). The metal elements 3.2 are then inserted into a mould or mask 7 or into recesses 8 provided there, the form of these recesses being adapted to the form of the metal elements 3.2 so that each metal element 3.2 is accommodated in a form-fitting manner in the corresponding recess 8. The insertion of the metal elements 3.2 takes place for example by first randomly placing them n the mask 7 and then by subsequent shaking of the mask 7 in the manner that in the end each metal element 3.2 is accommodated in the corresponding recess 8 and protrudes over the top side of the mask 7 comprising the recesses 8 (Position b).

The substrate 2 is provided on the full surface with the adhesive or bond layer 5 (Position c) and then afterwards turned and placed with the adhesive and bond layer 5 from above onto the mask 7 or onto the metal elements 3.2 held in said mask (Position d). After hardening or curing of the adhesive or bond layer 5 the mask 7 is removed so that then the metal elements 3.2 forming the structured metallizations 3.1 are held on the substrate 2 by means of the through-connecting adhesive or bond layer 5 and, after turning of the substrate 2, the state depicted in Position e is achieved. In a further process step the adhesive or bond layer 5 between the structured metal areas 3.1, for example again by sandblasting and/or by plasma treatment (Position f), so that the metal areas 3.1 are again held on the ceramic substrate by means of the structured adhesive and bond layer 5.1. In further process steps, a post-treatment process takes place for example, such as was described above in connection with FIG. 4.

This process is especially efficient and ecological, since the removal of metal or copper by etching for achieving the structured metal areas 3.1 is not necessary, since the metal elements or pads 3.2 forming the later structured metal areas 3.1 are produced in a time-saving manner by stamping and no residue from etching is produced, which would require elaborate preparation and/or disposal.

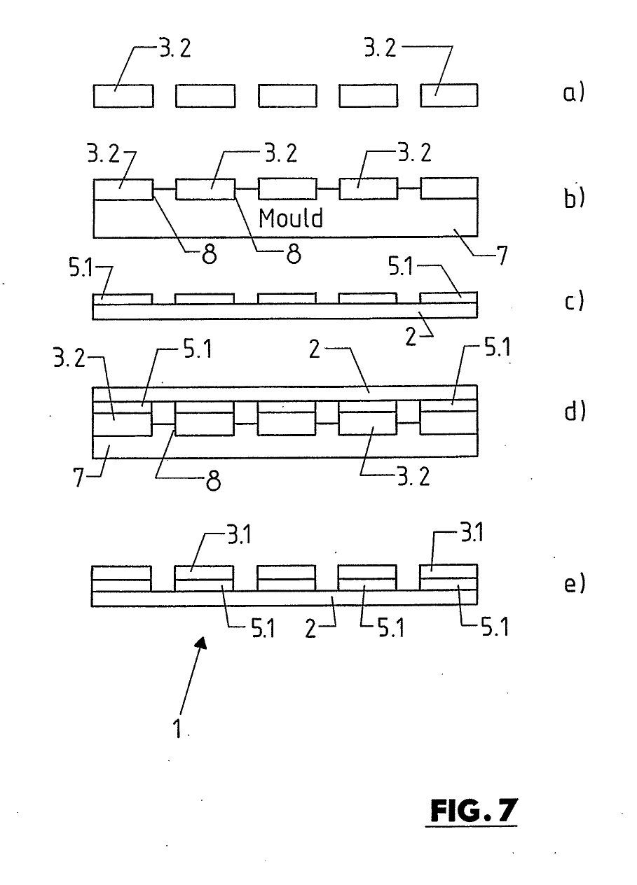

FIG. 7 shows a process in which in the same manner as described above for the process of FIG. 6, first the metal elements 3.1 are stamped from the metal foil and then inserted into the corresponding recesses 8 of the mask 7 (Positions a and b). The application of the adhesive or bond layer 5 onto the substrate 2 takes place in this process again in structured form, i.e. by means of a suitable technique, e.g. screen printing and/or the use of masks, structured areas 5.1 are formed where a metal element 3.2 is to be bonded to the substrate 2 for forming a structured metal area 3.1 (Position c). Afterwards, the substrate 2 is turned and place onto the metal elements 3.2 arranged in the mask 7 (Position d), so that after hardening of the adhesive or bond material or of the structured areas 5.1 and after removal of the mask 7 and turning of the substrate 2 the metal-ceramic substrate 1 structured on the top side is already produced (Position e), which is then supplied for post-treatment, if necessary.

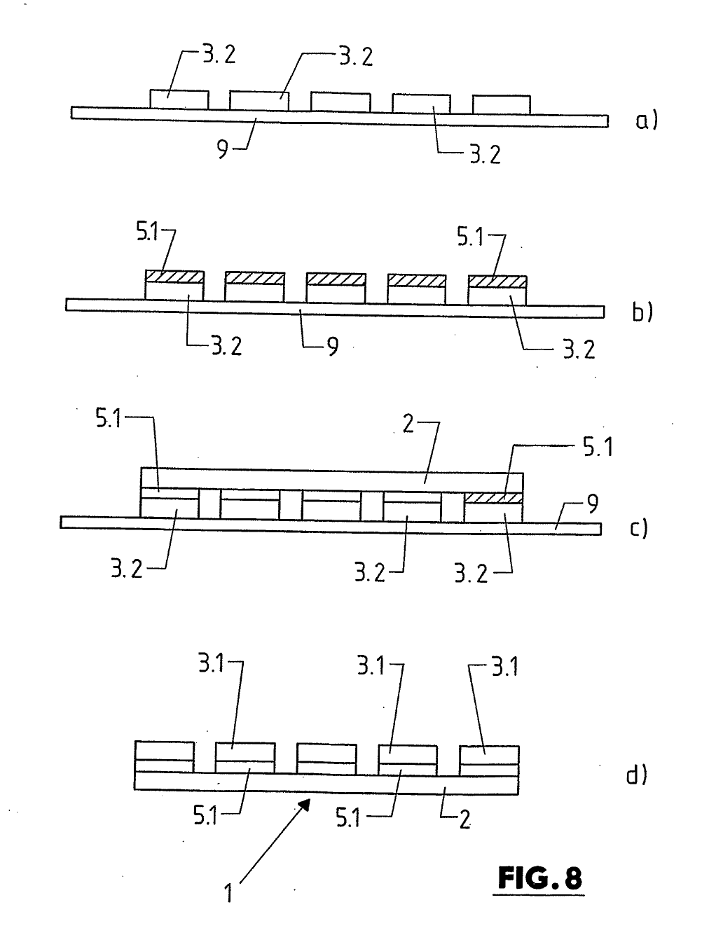

It was assumed above that the adhesive or bond material is applied to the substrate 2 as a through-connecting adhesive or bond layer 5 or as a structured adhesive or bond layer 5.1, respectively. Fundamentally, it is also possible to apply adhesive or bond material to the copper foil forming the metallization 3 or to the metal elements 3.2 already produced for example by stamping from a metal foil. A process of the latter type is depicted schematically in FIG. 8 with its essential process steps. First, a carrier material 9, for example in the form of a carrier foil is made available, on which the metal elements or pads 3.2 forming the later structured metal areas 3.1 are provided in the required form and spatial arrangement, i.e. the layout of the structured metallization 3. The carrier material 9 with the metal elements 3.2 is produced for example in the manner that a metal or copper foil laminated on one side with the carrier material 9 is structured by means of an etching or masking technique and/or the metal elements 3.2 stamped from a flat material are positioned in the required manner with at least one mask and then bonded to the carrier material 9 using a bonding means.

The adhesive or bond material is then applied to the surface side of the metal elements 3.2 facing away from the carrier material 9, namely for example using a screen printing technique, so that an area of the structure adhesive or bond layer 5.1 is provided on each metal element 3.2 (Position b). In a further process step the substrate 2 is then placed onto the metal elements 3.2 provided with the adhesive or bond material (Position c), namely with metal elements 3.2 still being held on the carrier material 9. After hardening of the adhesive or bond material the carrier material 9 is then removed by peeling it off, so that the metal-ceramic substrate 1 structured on the top side is produced.

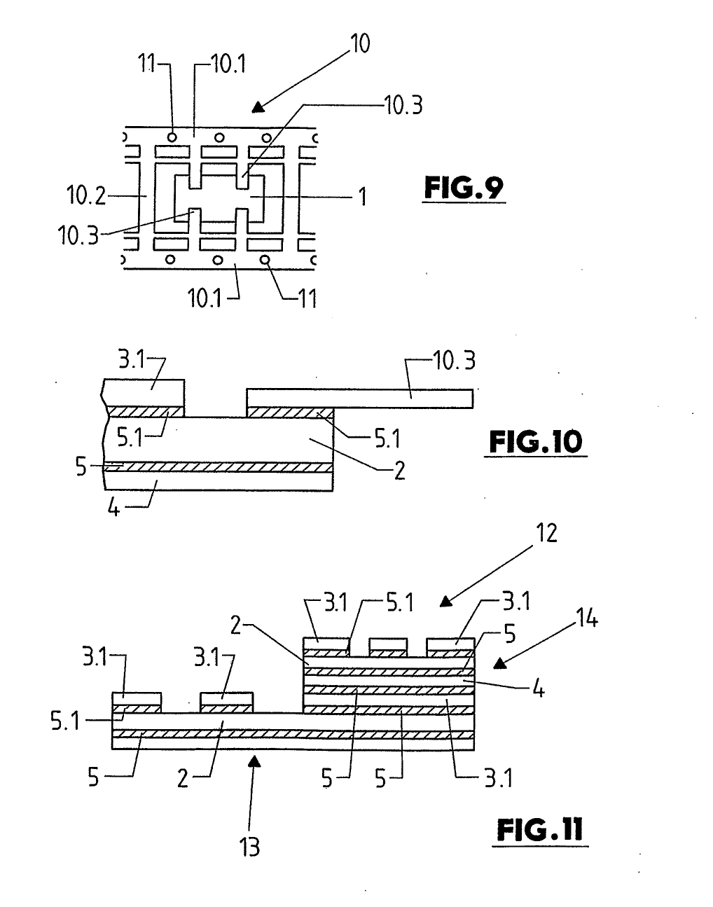

FIG. 9 shows in a very simplified schematic depiction a partial length of a leadframe 10, which is made in the known manner in one piece from a metal flat material with sections 10.1 extending respectively in the leadframe longitudinal direction and forming the longitudinal sides of the leadframe 10 with positioning openings 11, with bridges 10.2 through-connecting the two sections 10.2 in the manner of a ladder and with bridge sections 10.3 located in between and forming later connections.

Between the sections 10.1 and the through-connecting bridges 10.2 several metal-ceramic substrates 1 are provided, positioned exactly, which form the basis for electrical circuits or modules and which are mounted with corresponding components in a later process step. The substrates 1 are for example metal-ceramic substrates which were manufactured using one of the processes described above, or for example DCB substrates or substrates manufactured by active soldering. The metallization on at least one surface side, for example the metallization 3, is structure for forming strip conductors, contact surfaces, mounting surfaces, etc. The bridge sections 10.3 are, as shown enlarged in FIG. 10, bonded with their free end to one surface side of the substrate 2, namely in the depicted embodiment to the surface side of the substrate 2 on which also the structured metal areas 3.1 are provided. The bond between the bridge sections 10.3 and the substrate 2 is achieved by means of an adhesive or bond layer 5 or a structured adhesive or bond layer 5.1. After mounting of the substrate 1 with the components and after injection moulding of the substrates and the components with a mass forming the case of the respective module, the bridge sections 10.3 are stamped free to form connections or leads guided outward in the manner known to persons skilled in the art.

FIG. 11 shows in a very simplified depiction and in side view a multiple substrate 12, which consists of two single substrates 13 and 14, which are designed respectively as metal-ceramic substrates and the single substrate 14 of which is attached to the single substrate 13 by bonding or adhesion. The single substrate 13 in turn consists of the substrate 2 and the two metallizations 3 and 4 on the top and bottom side of the substrate 2, the metallization 3 being structured or comprises the structured metal areas 3.1. The single substrate 14 likewise consists of a substrate 2, of an upper and lower metallization 3 and 4, one of the two metallizations, namely the upper exposed metallization 3 being structured. The metallizations 3 and 4 in the case of the single substrates are bonded to the respective substrate 2 either using DCB technology and/or active soldering or by the adhesive and bond layers 5 or the structured areas 5.1. The bonding of the single substrate 14 to the single substrate 15 is achieved by means of an adhesive or bond layer 5.

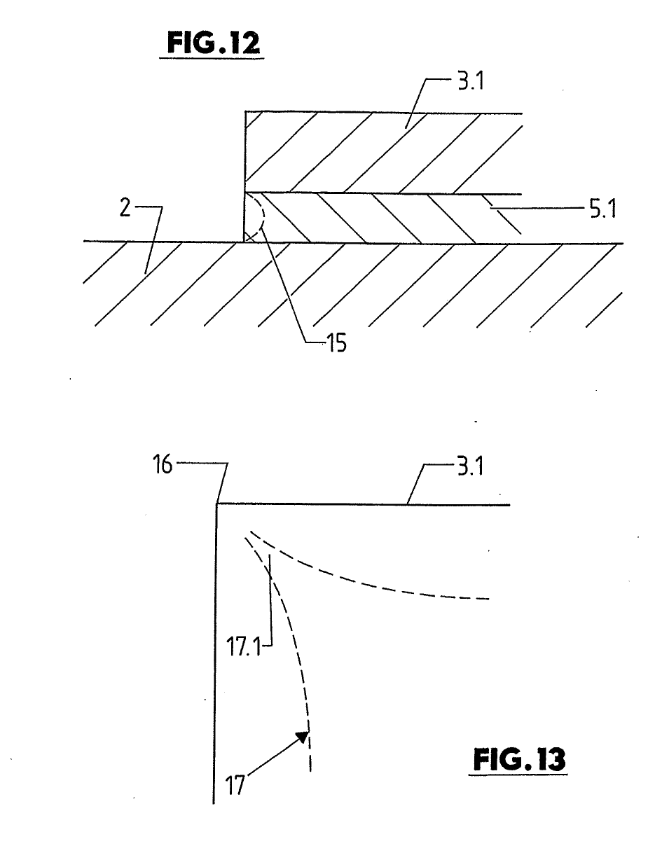

Everywhere that the adhesive or bond material is structured, i.e. applied in the form of structured areas 5.1, it is at least expedient to choose the quantity and/or distribution of the adhesive and bond material in the respective structured area of the structured adhesive or bond layer 5.1 and the form of this area so that after bonding, the entire gap formed between one structured metal area 3.1 and the substrate 2 is completely filled with the adhesive and bond material and this material in any case also reaches as far as the edge of the respective structured metal area 3.1, as depicted schematically in FIG. 12 for the structured adhesive or bond layer 5.1 beneath the structured metal area 3.1, so that in no case are there any cavities at the edge area of the metallization or of the structured metal area 3.1, as indicated by the line 15 in FIG. 12.

In order especially also to prevent such cavities 15 in outer, i.e. convex corner areas 16 of the respective structured metal area 3.1 and at the same time to prevent the adhesive or bond material from oozing over the edge of the respective structured metal areas 3.1 during bonding, the structured application of this material takes place corresponding to the dotted line 17 in FIG. 13 for example in the form that the application of the adhesive and bond material generally is somewhat smaller than the surface of the structured metal area 3.1 to be bonded and that the application of the adhesive or bond material in the area of the corners 16 is brought more thickly toward the edge of the structured metal area 3.1 or toward the edge area of the surface of the substrate 2 covered by the structured metal area 3.1, as indicated by the lobe-shaped area 17.1 in FIG. 13.

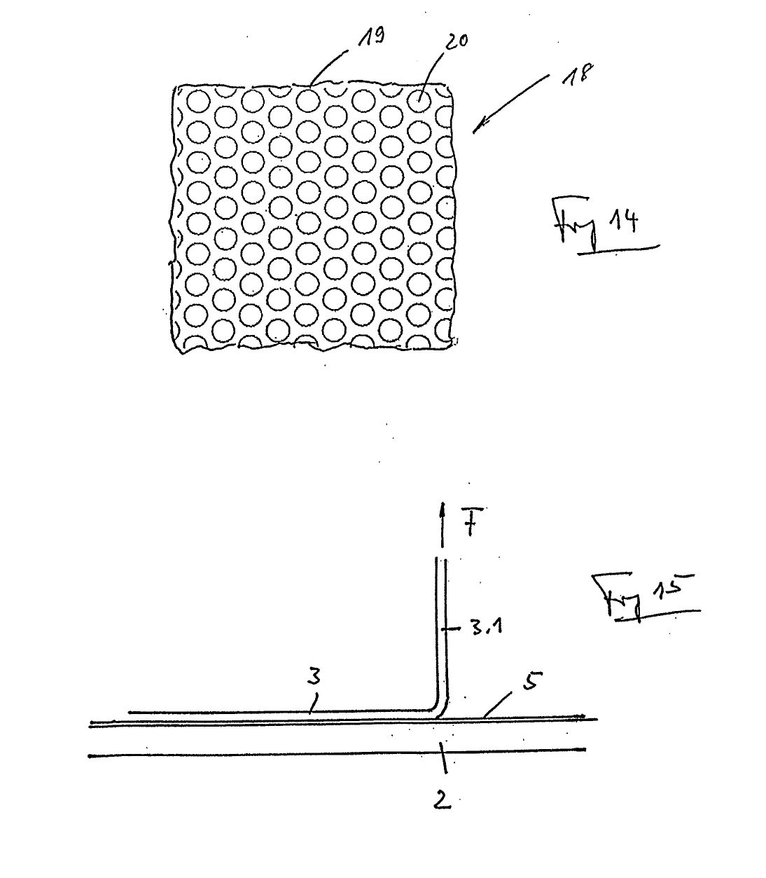

FIG. 14 shows a partial representation in top view of a mask 18 designed as a hole mask, which consists essentially of a flat material 19, for example of a metal flat material or of a flat material made of plastic and is provided with a plurality of through-connecting mask openings or holes 20, which in the depicted embodiment have the same hole size respectively. The mask 18 is used to apply a temporary quantity of adhesive or bond material to the respective carrier substrate 2 and for this purpose is placed on this carrier substrate 2. Afterwards, the adhesive and bond material is applied to the surface side of the mask 18 facing away from the carrier substrate 2, namely in the manner that in particular also the openings 20 are completely filled with the adhesive and bond material. A scraper or doctor blade is used to remove the bond or adhesive material from the mask 18 which was not taken up in the openings 20. Afterwards, the mask 18 is removed from the carrier substrate 2 so that a plurality of applications of the adhesive and bond material corresponding to the mask holes 20 is then present on the carrier substrate 2, namely respectively with a volume corresponding to the respective mask openings 20. Afterwards, the adhesive and bond material is distributed full-surface on the carrier substrate, namely at least where the metallization 3 and 4 is to be applied later. After this distribution, a layer of the adhesive and bond material with the desired thickness is obtained on the carrier substrate 2, on which (layer) the foil forming the metallization 3 and 4 is then placed.

In a preferred embodiment the flat material 19 has for example a thickness of 0.03 mm. The diameter of the circular holes 20 is 2.45 mm and the distance from hole to hole is 1 mm, so that this hole mask 18 produces a thickness for the adhesive and bond material applied to the carrier substrate 2 and where it is distributed evenly on the order of approximately 14 μm.

FIG. 15 shows a measuring array 21 for determining the bond strength or peel-off strength of the respective metallization 3 and on the carrier substrate 2. The figure shows carrier substrate 3, on a surface side of which one metallization, for example the metallization 3 is applied using the adhesive or bond layer 5 in the form of a metal strip with a pre-defined width x in such a manner that a partial length 3.1 of the metallization or of the metal strip protrudes, flag-like, from the top side of the carrier substrate 2. A tensile strength corresponding to the arrow F is exerted on the partial length 3.1. The bond strength or peel-off strength is defined as the quotient

Peel-off strength=F_{PO}/x,

where

F_{PO} is the minimum force (specified in N) necessary for peeling off the metallization 3 or the metal or test strip formed by this metallization, and

x (specified in mm) is the width of the metal or test strip.

By corresponding composition of the adhesive or bond material, a bond strength of at least 1 N/mm, preferably at least 2.5 N/mm is desired for the bond material according to the invention.

The invention was described above based on various exemplary embodiments. It goes without saying that numerous embodiments are possible, without abandoning the underlying inventive idea upon which the invention is based. For example, the metallizations 3 and 4 can consist at least in partial areas of a layer or foil made of a different metal than copper, for example of aluminum or of a highly resistive metal material.

It was further assumed above that the carrier substrate 2 is a ceramic substrate or a ceramic layer. Fundamentally, it is also possible to use as a carrier substrate such a glass, i.e. a glass substrate or a carrier substrate which consists at least partially of ceramic and of glass, for example of a ceramic with a glass layer on at least one surface side.

### REFERENCE LIST

1 metal-ceramic substrate
2 carrier substrate, e.g. ceramic and/or glass layer
3, 4 metallization
3.1 structured metal area
3.2 metal pad
5 adhesive or bond layer
5.1 structured area of adhesive and bond layer
6 line
7 mask
8 recess
9 carrier material or carrier foil
10 leadframe
10.1 leadframe section
10.2 leadframe bridge
10.3 bridge section
11 positioning opening
12 multiple module
13, 14 single module
15 cavity
16 corner area
17 form of structured adhesive and bond material coating
17.1 lobe-shaped area
18 hole mask
19 flat material
20 mask opening
21 test device for determining adhesive strength

1-60. (canceled)

61. A composite material, comprising:
a carrier substrate comprising a ceramic or glass on at least on one surface side of an electrically insulating material,
at least one metallization formed by a metal layer on one surface side of the carrier substrate, and
wherein an adhesive or bond layer bonds the at least one metallization to the carrier substrate, the adhesive or bond layer contains at least one nanofiber material in a plastic matrix.

62. The composite material according to claim 61, wherein the carrier substrate is plate-shaped, and the carrier substrate is a ceramic layer, a glass layer, an aluminum oxide, an aluminum nitride or a silicon nitride ceramic, and the at least one metallization includes a first metallization provided on a top side of the carrier substrate and a second metallization provided on a bottom side of the carrier substrate, and at least one of the first or the second metallization is structured.

63. The composite material according to claim 61, wherein the at least one metallization in the area of the adhesive or bond layer exhibits a distance from an adjoining layer of from 5 μm to 50 μm.

64. The composite material according to claim 61, wherein the adhesive or bond layer bonding the at least one metallization to the carrier substrate is chosen with respect to a layer thickness or a composition so that a thermal resistance exhibited by the adhesive or bond layer in an axial direction perpendicular to mutually adjoining surface sides of the at least one metallization and the carrier substrate is at a maximum equal to a thermal resistance of the carrier substrate in the axial direction.

65. The composite material according to claim 61, wherein the at least one nanofiber material is a carbon nanofiber material, and a content of the carbon nanofiber material in the adhesive or bond layer is between 5 and 30 percent by weight, relative to a total weight of the composite material, and the at least one nanofiber material is made of nanofibers or nanotubes, at least a majority of the nanofibers or the nanotubes having a length between 1 μm and 100 μm and a thickness between 1 nm and 300 nm.

66. The composite material according to claim 61, wherein the at least one metallization, the carrier substrate, or both, in an area of the adhesive or bond layer are provided with a surface roughness, the at least one metallization has a surface roughness between 1 μm and 7 μm and the carrier substrate has a surface roughness between 4 and 10 μm, the surface roughness of the at least one metallization and the surface roughness of the carrier substrate being mechanically, physically or chemically produced by sandblasting, by intergranular etching, by plasma treatment, or by deposition of a layer comprising copper and a further metal and by subsequent etching of the further metal.

67. The composite material according to claim 61, wherein the plastic matrix of the adhesive or bond layer comprises an epoxy base or an epoxy-resin base and the adhesive or bond layer contains additives, flame-retarding additives, halides or boron compounds.

68. The composite material according to claim 61, wherein a plastic forming the plastic matrix of the adhesive or bond layer is in hardened or cured condition and has a temperature resistance of at least 220° C.

69. The composite material according to claim 61, wherein the at least one metallization at least in partial areas comprises a metal alloy, a metal composite, a multi-layer material, comprising an aluminum and copper multi-layer material, the at least one metallization consists at least partially of copper, a copper alloy, aluminum, an aluminum alloy, a highly resistive metal material, or at least one metal foil, selected from the group consisting of copper, a copper alloy, aluminum, an aluminum alloy and a highly resistive metal material.

70. The composite material according to claim 61, wherein the at least one metallization has a thickness between 0.01 mm and 4 mm, and the carrier substrate has a thickness between 0.1 mm and 1.2 mm.

71. The composite material according to claim 61, wherein the adhesive or bond layer bonds the at least one metallization to the carrier substrate with a bonding strength of at least 1 N/mm.

72. The composite material according to claim 61, wherein the at least one metallization is structured for forming structured metal areas in the form of strip conductors, contact surfaces, or mounting surfaces, and the adhesive or bond layer is not provided or is removed between adjoining structured metal areas, and the at least one metallization at least on one surface side of the carrier substrate forms an electrical connection protruding over one edge area of the composite material, and the carrier substrate or the at least one metallization is bonded by means of the adhesive or bond layer made to a leadframe or to bridge sections of the leadframe.

73. The composite material according to claim 61, wherein the carrier substrate is made of two single substrates, and the two single substrates are bonded to each other by means of at least one adhesive or bond layer.

74. The composite material according to claim 61, wherein the adhesive or bond layer is free of gas or vapor bubbles, or has a content by volume of such bubbles relative to a total volume of the adhesive or bond layer no more than 0.1 percent by volume, and the adhesive or bond layer also contains pulverized additives selected from the group consisting of carbon, graphite, ceramic and metal additives.

75. The composite material according to claim 61, wherein the at least one nanofiber material is a metal-free or essentially metal-free nanofiber material, and is without Ni, Fe or Co and is a thermally or chemically pre-treated nanofiber material.

76. The composite material according to claim 61, wherein a total content of the at least one nanofiber material and additional constituents in the plastic matrix of the adhesive or bond layer is chosen so that a glass transition temperature of the adhesive or bond material or of the plastic matrix is at least 150° C. and is higher by at least 25% compared with a glass transition temperature of a plastic forming the plastic matrix, and the total content of the at least one nanofiber material and the additional additives is 25% by volume relative to a total mass of the adhesive or bond layer.

77. The composite material according to claim 61, wherein a total content of nanofiber material and additional additives is chosen so that a thickness of less than 25 μm is possible for the adhesive or bond layer, and the total content of nanofiber material and the additional additives is chosen so that the thermal conductivity of the adhesive or bond layer is greater by at least a factor of five compared with a thermal conductivity exhibited by a plastic forming the plastic matrix.

78. A method for manufacturing a composite material comprising a carrier substrate comprising a ceramic or glass comprising on at least on one surface side, an electrically insulating material in the form of a ceramic, a glass layer, a ceramic substrate or a glass substrate, and comprising at least one metallization formed by a metal layer or metal foil on at least one surface side of the carrier substrate, comprising:
bonding the at least one metallization to the carrier substrate by bonding with an adhesive or bond material, wherein the adhesive or bond materials contains nanofiber material, or a carbon nanofiber material, in a plastic matrix, or in a plastic matrix with an epoxy base.

79. The method according to claim 78, further including the step of roughening the metal layer or metal foil or the carrier substrate prior to bonding on their surface sides to be bonded to each other, for achieving a surface roughness of 1 μm to 5 μm for the metal layer or foil and for achieving a surface roughness of 4 μm to 10 μm for the carrier substrate.

80. The method according to claim 79, wherein the surface roughness is produced mechanically, physically, or chemically, by sandblasting, by pumicing, by intergranular etching, by plasma treatment, or by deposition of a metal layer comprising the metal of the at least one metallization and a further metal and by subsequent removal of the further metal by etching.

81. The method according to claim 78, wherein the adhesive or bond material, which in addition to the nanofiber material, contains further additives, flame retardant additives, halides or nitride compounds.

82. The method according to claim 78, wherein the at least one metallization is bonded by means of the adhesive or bond material to the carrier substrate and the at least one metallization is structured.

83. The method according to claim 78, wherein the adhesive or bond material is applied full-surface to an area to be provided with the at least one metallization of an adjoining layer of the carrier substrate, and after structuring of the at least one metallization to create a structured metallization, the adhesive or bond material between metal areas of the structured metallization is removed mechanically, by sandblasting, by laser treatment or by plasma treatment, and the adhesive or bond material, prior to application of the at least one metallization to be structured, is applied in a form and position corresponding to a form and position of the metal areas of the structured metallization to the at least one metallization to be bonded or to the metal layer forming the at least one metallization or to the surface area of the adjoining layer to be provided with the at least one metallization of the carrier substrate.

84. The method according to claim 83, wherein for producing the structured metallization on one surface side of an adjoining layer, on a surface side of the carrier substrate, the metal areas of metal elements or pads forming the structured metallization by stamping are provided in a position corresponding to the structured metallization and bonded to the adjoining layer using the adhesive or bond material.

85. The method according to claim 84, wherein the provision of the metal elements or pads takes place by arranging the metal elements or pads in a mask or form or by positionally exact application of the metal elements or pads on an auxiliary carrier or a carrier material, and the adhesive or bond material is applied full-surface to a surface to be provided with the structured metallization of the carrier substrate and after bonding, curing or hardening of the adhesive or bond material the adhesive bond is removed between the metal areas of the structured metallization, mechanically, by sandblasting, by laser treatment or plasma treatment.

86. The method according to claim 84, wherein the adhesive or bond material is applied in structured form onto the surface side of the adjoining layer to be provided with the structured metallization in a form and position corresponding to the metal elements or pads of the structured metallization or is applied to the surface side of provided metal elements to be bonded to the adjoining layer.

87. The method according to claim 78, wherein the at least one metallization at least in partial areas comprises a foil made of copper or aluminum or of a highly resistive metal material, and the at least one metallization at least in partial areas consists of copper, aluminum or a metal alloy made of a copper alloy or aluminum alloy, or a metal composite, a multi-layer material made of an aluminum and copper multi-layer material.

88. The method according to claim 78, wherein the composite material, after application of the at least one metallization, for improving the thermal conductivity is post-treated by tempering, at a temperature equal to or higher than a bonding temperature used to cure the adhesive and bond material, the tempering taking place under pressure.

89. The method according to claim 78, wherein the adhesive and bond material is applied to the carrier substrate using masks, templates, screens, by spraying, rolling or spin-coating, the full-surface or structured application of the adhesive or bond material taking place using at least one mask, template or using a screen resist method.

90. The method according to claim 78, wherein a conditioning of the adhesive or bond material takes place so that the adhesive or bond layer formed by the adhesive or bond material at least in the finished composite material is free of gas or vapor bubbles, and a content by volume of such bubbles in the adhesive or bond layer relative to the total volume of this layer is no more than 0.1% by volume.

91. The method according to claim 78, wherein the adhesive or bond layer comprises pulverized additives, such as carbon, graphite, ceramic or metal additives.

92. The method according to claim 78, wherein the nanofiber material is a metal-free or essentially metal-free nanofiber material, a nanofiber material without Ni, Fe or Co or a chemically or thermally pre-treated nanofiber material.

93. The method according to claim 78, wherein the total content of the nanofiber material and any additional constituents in the plastic matrix of the adhesive or bond layer is chosen so that a glass transition temperature of the adhesive or bond material or of the plastic matrix is at least 150° C. and is higher by at least 25% compared with a glass transition temperature of a plastic forming the plastic matrix, and a total content of nanofiber material and any further additives is 25% by volume relative to the total mass of the adhesive or bond material.

94. The method according to claim 78, wherein the total content of nanofiber material and any further additives is chosen so that a thickness of less than 25 μm is possible for at least one adhesive or bond layer made up of the at least one adhesive or bond material.

95. The method according to claim 78, wherein a total content of nanofiber material and any additives is chosen so that the thermal conductivity of the adhesive or bond material is greater by at least a factor of four, with a thermal conductivity exhibited by a plastic forming the plastic matrix without nanofiber material and without any additional fillers.

96. An adhesive or bond material for manufacture of an adhesive or bond connection between a carrier substrate and a metallization comprising a plastic matrix containing at least one nanofiber material, wherein a content of nanofiber material and of any further additives in the plastic matrix is chosen so that the adhesive or bond material is suitable for processing with a layer thickness smaller than 25 μm,
and the nanofiber material is a carbon nanofiber material and a content of the nanofiber material in the adhesive or bond material is between 5 and 30 percent by weight, relative to a total weight of this material.

97. The adhesive or bond material according to claim 96, wherein the nanofiber material is made of nanofibers or nanotubes, a majority of the nanofibers or nanotubes having a length between 1 μm and 100 μm and a thickness between 1 nm and 300 nm.

98. The adhesive or bond material according to claim 96, wherein the plastic matrix is such a plastic matrix with an epoxy base or an epoxy-resin base, and
the bond material or adhesive contains further additives such as carbon, graphite, ceramic or flame-retardant additives, such as halides or boron compounds.

99. The adhesive or bond material according to claim 96, wherein the plastic material forming the plastic matrix is chosen so that in a hardened or a cured condition it has a temperature resistance of at least 220° C.

100. The adhesive or bond material according to claim 96, wherein the nanofiber material is a metal-free or essentially metal-free nanofiber material, a nanofiber material without Ni, Fe or Co or a chemically or is a thermally pre-treated nanofiber material.

101. The adhesive or bond material according to claim 96, wherein a total content of nanofiber material and any further additives is chosen so that a glass transition temperature of the bond material or adhesive and of the plastic matrix is at least 150° C. and is higher by at least 25% compared with a glass transition temperature of a plastic forming the plastic matrix, and a total content of nanofiber material and any further additives is 25% by weight relative to the total mass of the adhesive or bond layer.

102. The adhesive or bond material according to claim 96, wherein a total content of nanofiber material and any further additives is chosen so that a thermal conductivity of the bond material or adhesive is greater by at least a factor of five compared with a thermal conductivity exhibited by a plastic forming the plastic matrix.
